(19) United States
(12) Patent Application Publication
(10) Pub. No.: US 2025/0125426 A1
(43) Pub. Date: Apr. 17, 2025

(54) LAMINATE FILM, ELECTRODE STACK, AND BATTERY

(71) Applicant: TOYOTA JIDOSHA KABUSHIKI KAISHA, Aichi-ken (JP)

(72) Inventor: Tsuyoshi EHARA, Toyota-shi (JP)

(21) Appl. No.: 18/902,927

(22) Filed: Oct. 1, 2024

(30) Foreign Application Priority Data
Oct. 11, 2023 (JP) 2023-176085

(51) Int. Cl. H01M 10/0587

(52) U.S. Cl. CPC H01M 10/0587

(57) ABSTRACT

The present disclosure provides a laminate film and an electrode stack that is less likely to collapse the laminated structure of the electrode stack, and battery comprising such a laminate film or an electrode stack. The laminate film of the present disclosure is for producing a battery by sealing an electrode stack thereby. In the laminate film of the present disclosure, rod-shaped buffer members are fixed to the laminate film such that the rod-shaped buffer members contact with at least two opposing side surface parts of the electrode stack. The electrode stack of the present disclosure is for producing a battery by being sealed it with a laminate film. In the electrode stack of the present disclosure, rod-shaped buffer members are fixed to at least two opposing side surface parts of the electrode stack.

### FIELD

This disclosure relates to a laminate film, an electrode stack, and a battery.

### BACKGROUND

For example, as disclosed in PTL1, a laminate battery is known that includes an electrode stack, and a current collector terminal electrically connected to a current collector foil of the electrode stack, in which the electrode stack is sealed with a laminate film.

### CITATION LIST

### Patent Literature

[PTL 1]. Japanese Unexamined Patent Publication (Kokai) No. 2020-170583

### SUMMARY

### Technical Problem

Electrode stacks are usually fixed only by current collector tabs. Therefore, the stacked structure of the electrode stack may collapse, and the current collector tab may be damaged due to an external impact or the like on the electrode stack.

An object of the present disclosure is to provide a laminate film and an electrode stack that is less likely to collapse the laminated structure of the electrode stack, and battery comprising such a laminate film or an electrode stack.

### Solution to Problem

The present inventors have discovered that the above object can be achieved by the following means.

### <Aspect 1>

A laminate film for producing a battery by sealing an electrode stack thereby, wherein rod-shaped buffer members are fixed to the laminate film such that the rod-shaped buffer members contact with at least two opposing side surface parts of the electrode stack.

### <Aspect 2>

The laminate film according to Aspect 1, wherein the length of the rod-shaped buffer members in the stacking direction of the electrode stack is the same as or less than the thickness of the electrode stack.

### <Aspect 3>

A battery comprising an electrode stack and the laminate film according to Aspect 1 or 2 sealing the electrode stack.

### <Aspect 4>

An electrode stack for producing a battery by being sealed it with a laminate film, wherein rod-shaped buffer members are fixed to at least two opposing side surface parts of the electrode stack.

### <Aspect 5>

A battery comprising the electrode stack according to Aspect 4 and a laminate film sealing the electrode stack.

### Advantageous Effects of Invention

According to the present disclosure, a laminate film and an electrode stack that is less likely to collapse the laminated structure of the electrode stack, and battery comprising such a laminate film or an electrode stack can be provided.

### BRIEF DESCRIPTION OF DRAWINGS

FIG. 1 is a schematic perspective view showing an example of an electrode stack and a laminate film of the present disclosure before sealing the electrode stack.

FIG. 2 is a schematic perspective view showing an example of an electrode stack of the present disclosure.

FIG. 3 is a schematic plan view showing an example of a battery of the present disclosure.

### DESCRIPTION OF EMBODIMENTS

Hereinafter, embodiments of the present disclosure will be described in detail. Note that the present disclosure is not limited by the following embodiments, and various modifications can be made within the scope of the disclosure.

### <<Laminate Film>>

The laminate film of the present disclosure is for producing a battery by sealing an electrode stack thereby. In the laminate film of the present disclosure, rod-shaped buffer members are fixed to the laminate film such that the rod-shaped buffer members contact with at least two opposing side surface parts of the electrode stack.

As described above, electrode stacks are usually fixed only by current collector tabs. Therefore, the stacked structure of the electrode stack may collapse, and the current collector tab may be damaged due to an external impact or the like on the electrode stack.

In this regard, the present inventors have found that the electrode stack can be easily fixed by providing the rod-shaped buffer members for fixing the electrode stack on the side surface part of the electrode stack, and thereby the current collector tab can be prevented from being damaged even if an external impact or the like is applied to the electrode stack.

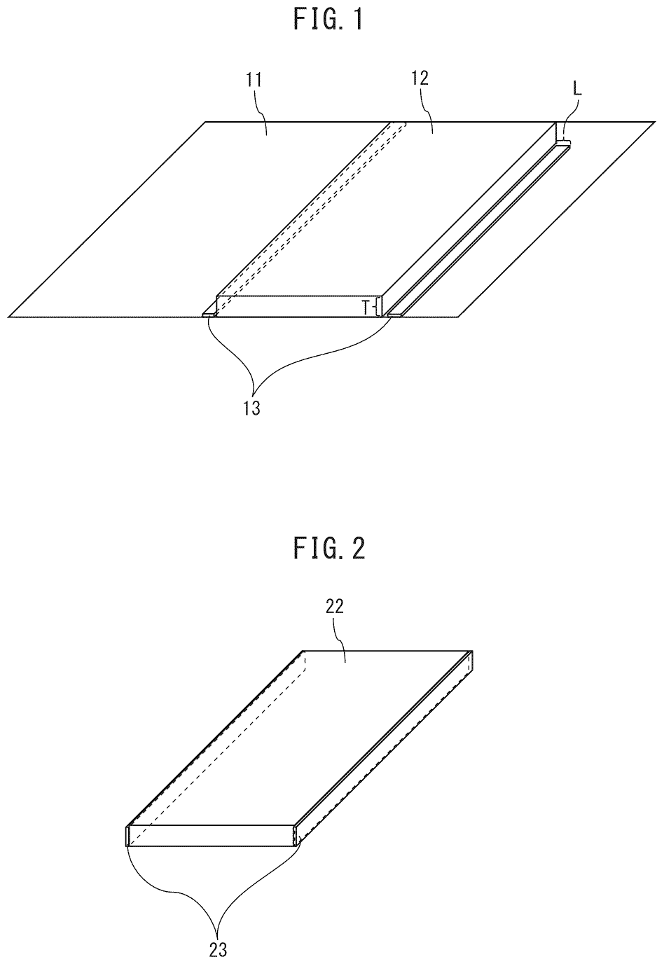

Hereinafter, the laminate film 11 of the present disclosure will be described with reference to FIG. 1. The dimensional relationships (length, width, thickness, and the like) in the drawings of the present disclosure do not reflect actual dimensional relationships.

FIG. 1 is a schematic perspective view showing an example of an electrode stack 12 and a laminate film 11 of the present disclosure before sealing the electrode stack 12.

The shape of the electrode stack 12 is not particularly limited, as shown in FIG. 1, for example, it may have a top surface part, a bottom surface part facing the top surface part, and four side surface parts connecting the top surface part and the bottom surface part. In the laminate film 11 of the present disclosure, rod-shaped buffer members 13 fixed to a position in contact with at least two opposing side surface parts of the electrode stack 12.

In the electrode stack 12, a current collector terminal may be disposed on the side surface part. In this case, the two opposing side surface parts can be side surface parts on which no current collector terminal is disposed.

The rod-shaped buffer members 13 are not particularly limited if it is disposed on at least two opposing side surface parts of the electrode stack 12 and can fix the electrode stack 12 when the battery is produced. Examples of the material for the rod-shaped buffer members 13 include resin.

The position of the rod-shaped buffer members 13 in the laminate film 11 can be designed accordingly, considering the size of the electrode stack 12.

A method of disposing the rod-shaped buffer members 13 on the laminate film 11 is not particularly limited, and examples thereof include a method of bonding with an adhesive or the like.

The length (L) of the rod-shaped buffer members 13 in the stacking direction of the electrode stack 12 may be the same as or less than the thickness (T) of the electrode stack 12. With such a configuration, for example, when a plurality of batteries including the laminate film 11 to which the rod-shaped buffer members 13 are fixed are stacked and restrained to form a battery module, the rod-shaped buffer members 13 can be prevented from interfering with the pressure equalization of the battery.

A method of manufacturing the rod-shaped buffer members 13 is not particularly limited. For example, when the rod-shaped buffer members 13 are made of resin, a method of injection molding a resin to a desired size, a method of cutting a flat resin to a desired size, and the like can be exemplified.

### <<Electrode Stack>>

The electrode stack of the present disclosure is for producing a battery by being sealed it with a laminate film. In the electrode stack of the present disclosure, rod-shaped buffer members are fixed to at least two opposing side surface parts of the electrode stack.

The present inventors have found that the electrode stack can be easily fixed, and thereby the current collector tab can be prevented from being damaged even if an external impact or the like is applied to the electrode stack with such a configuration as well.

FIG. 2 is a schematic perspective view showing an example of an electrode stack 22 of the present disclosure. As shown in FIG. 2, in the electrode stack 22 of the present disclosure, the rod-shaped buffer members 23 are fixed to at least two opposing side surface parts.

Regarding the two opposing side surface parts, and the rod-shaped buffer members 23, the above description regarding the laminate film of the present disclosure can be referred to.

A method of disposing the rod-shaped buffer members 23 on the two opposite side surface parts of the electrode stack 22 is not particularly limited, and examples thereof include a method of bonding with an adhesive or the like.

Also, the length (thickness) of the rod-shaped buffer members 23 in the stacking direction of the electrode stack 22 may be the same as or less than the thickness of the electrode stack 22.

### <<Battery>>

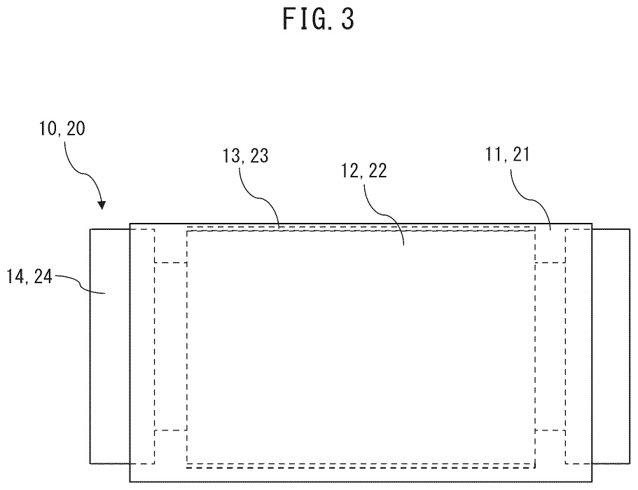

FIG. 3 is a schematic plan view showing an example of a battery of the present disclosure as viewed from the stacking direction of the electrode stack. As shown in FIG. 3, the battery 10 of the present disclosure comprises the electrode stack 12 and the laminate film 11 of the present disclosure sealing the electrode stack 12. Also, the battery 20 of the present disclosure comprises the electrode stack 22 of the present disclosure and the laminate film 21 sealing the electrode stack 22 of the present disclosure.

Also, as shown in FIG. 3, the battery 10, 20 of the present disclosure may additionally have a current collector terminal 14, 24, which is electrically connected to a current collector foil of the electrode stack 12, 22. Although the size, shape, and so on of the current collector terminal are not particularly limited, the laminate film 11, 21 may seal the electrode stack 12, 22 together with the current collector terminal 14, 24. Specifically, the laminate film 11, 21 may be wound around the electrode stack 12, 22 and the current collector terminal 14, 24 to seal the electrode stack 12, 22 together with the current collector terminal 14, 24. The laminate film 11, 21 may be composed of first and second films, and in this case, the first and second films may sandwich the electrode stack 12, 22 and the current collector terminal 14, 24 from the above and below in the stacking direction of the electrode stack 12, 22, and seal the electrode stack 12, 22 together with the current collector terminal 14, 24.

The electrode stack 12, 22 functions as a power generation element for the battery 10, 20. The electrode stack 12, 22 may have a negative electrode current collector, a negative electrode active material layer, an electrolyte layer, a positive electrode active material layer, and a positive electrode current collector in this order.

The battery of the present disclosure may be a liquid-based battery or a solid-state battery. A “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

The battery of the present disclosure may be a lithium ion secondary battery. Applications for batteries include, for example, a power source for vehicles such as hybrid vehicles (HEV), plug-in hybrid vehicles (PHEV), battery electric vehicles (BEV), gasoline-powered vehicles, and diesel-powered vehicles. In particular, it is preferably used as a power source for driving hybrid vehicle s (HEV), plug-in hybrid vehicles (PHEV), or battery electric vehicles (BEV). The battery of the present disclosure may also be used as a power source for moving objects other than vehicles (e.g., trains, ships, aircraft) and may be used as a power source for electrical products such as information processing devices.

### REFERENCE SIGNS LIST

10, 20 Battery
11, 21 Laminate film
12, 22 Electrode stack
13, 23 Rod-shaped buffer member
14, 24 Current collector terminal

1. A laminate film for producing a battery by sealing an electrode stack thereby, wherein
rod-shaped buffer members are fixed to the laminate film such that the rod-shaped buffer members contact with at least two opposing side surface parts of the electrode stack.

2. The laminate film according to claim 1, wherein the length of the rod-shaped buffer members in the stacking direction of the electrode stack is the same as or less than the thickness of the electrode stack.

3. A battery comprising an electrode stack and the laminate film according to claim 1 sealing the electrode stack.

4. An electrode stack for producing a battery by being sealed it with a laminate film, wherein
rod-shaped buffer members are fixed to at least two opposing side surface parts of the electrode stack.

5. A battery comprising the electrode stack according to claim 4 and a laminate film sealing the electrode stack.
